(19) United States
(12) Patent Application Publication
(10) Pub. No.: US 2026/0211192 A1
(43) Pub. Date: Jul. 23, 2026

(54) AUXILIARY TOOL AND CONNECTOR WITH AUXILIARY TOOL

(71) Applicant: Fujikura Ltd., Tokyo (JP)

(72) Inventor: Shuhei Kanno, Sakura-shi (JP)

(73) Assignee: Fujikura Ltd., Tokyo (JP)

(21) Appl. No.: 19/143,143

(22) PCT Filed: Dec. 19, 2023
(86) PCT No.: PCT/JP2023/045462

§ 371 Date: Jun. 25, 2025

(30) Foreign Application Priority Data
Dec. 27, 2022 (JP) 2022-210274
Sep. 13, 2023 (WO) PCT/JP2023/033330

(51) Int. Cl. G02B 6/38

(52) U.S. Cl. CPC G02B 6/3898; G02B 6/3825; G02B 6/3887

(57) ABSTRACT

An auxiliary tool for connecting connectors including optical fibers to an adapter, includes: a first housing; and a second housing. The first housing has: a first opening through which the connectors protrude toward the adapter, and a second opening facing the second housing. The second housing has pressing portions configured to press the connectors. The first housing has release portions inside each configured to abut a respective one of the connectors when the first housing is separated from the adapter.

### TECHNICAL FIELD

The present invention relates to an auxiliary tool and a connector with an auxiliary tool.

Priority is claimed on Japanese Patent Application No. 2022-210274, filed Dec. 27, 2022 and International Patent Application No. PCT/JP2023/033330, filed Sep. 13, 2023, the contents of which are incorporated herein by reference.

### BACKGROUND

In recent years, miniaturization and high density of connectors in data centers have been progressing. Accordingly, it is desired to improve work efficiency in a case of connecting or disconnecting a plurality of connectors by collectively operating the plurality of connectors. For example, Patent Document 1 discloses a configuration in which four connectors can be disconnected at the same time.

### PATENT LITERATURE

Patent Document 1: United States Patent Application, Publication No. 2019/285806 In the configuration of Patent Document 1, it is possible to collectively disconnect a plurality of connectors, but it is not possible to collectively connect the plurality of connectors. Therefore, in order to perform the collective connection, it is necessary to prepare a separate tool, for example. Preparing separate tools for the connection operation and the disconnection leads to a decrease in work efficiency.

### SUMMARY

One or more embodiments of the present invention provide an auxiliary tool and a connector with an auxiliary tool capable of collectively connecting and disconnecting a plurality of connectors.

According to an aspect 1 of the present invention, there is provided an auxiliary tool for connecting a plurality of connectors having optical fibers to an adapter, the auxiliary tool including: a first housing; and a second housing, in which the first housing has a first opening through which the plurality of connectors protrude toward the adapter, and a second opening facing the second housing, the second housing has a plurality of pressing portions configured to press the plurality of connectors, and a plurality of release portions each configured to, in a case where the first housing is separated from the adapter, abut respective one of the plurality of connectors, are provided inside the first housing.

An aspect 2 of the present invention is the auxiliary tool according to the aspect 1, in which the plurality of pressing portions of the second housing are configured to enter an inside of the first housing from the second opening to press the plurality of connectors.

An aspect 3 of the present invention is the auxiliary tool according to the aspect 1 or 2, in which, in a parallel direction in which the first housing and the second housing are arranged, positions of the plurality of pressing portions are different from each other.

An aspect 4 of the present invention is the auxiliary tool according to any one of the aspects 1 to 3, in which, in a parallel direction in which the first housing and the second housing are arranged, positions of the plurality of release portions are different from each other.

An aspect 5 of the present invention is the auxiliary tool according to any one of the aspects 1 to 4, in which the first housing includes a contact surface configured to, in a case where the plurality of pressing portions press the plurality of connectors, come into contact with the plurality of pressing portions, and a plurality of avoidance holes which are provided on the contact surface and into which the plurality of pressing portions enter after the plurality of pressing portions connect the plurality of connectors to the adapter.

An aspect 6 of the present invention is the auxiliary tool according to any one of the aspects 1 to 5, further including a handle attached to the first housing.

An aspect 7 of the present invention is a connector with an auxiliary tool, including: the auxiliary tool according to any one of the aspects 1 to 6; and the plurality of connectors inserted into an inside of the first housing and the second housing, in which each of the plurality of connectors includes a plurality of optical fibers, a ferrule having a plurality of fiber holes into which the plurality of optical fibers are inserted, a housing configured to hold the ferrule, an engagement protrusion configured to engage with the engagement hole of the adapter, and a boot that is located at an end portion of the connector on a side opposite to the ferrule.

An aspect 8 of the present invention is the connector with an auxiliary tool according to the aspect 7, in which, in a parallel direction in which the first housing and the second housing are arranged, a distance from the first opening to the second opening is shorter than a distance from a connection end surface of the ferrule to a rear end of the boot.

An aspect 9 of the present invention is the connector with an auxiliary tool according to the aspect 7 or 8, in which the second housing is configured to move to be separated from the first housing until the boot is exposed.

An aspect 10 of the present invention is the connector with an auxiliary tool according to any one of the aspects 7 to 9, in which the boot includes an abutting piece that protrudes downward from a lower end portion of the boot and extends to a proximal end side, and the plurality of pressing portions of the second housing are configured to press the boot toward a distal end side by abutting the abutting piece.

An aspect 11 of the present invention is the connector with an auxiliary tool according to the aspect 10, in which two protrusions protruding upward from a lower end portion of the second housing are provided on each of the plurality of pressing portions.

According to the above-described aspects of the present invention, it is possible to provide an auxiliary tool and a connector with an auxiliary tool capable of collectively connecting and disconnecting a plurality of connectors.

### BRIEF DESCRIPTION OF THE DRAWINGS

FIG. 1 shows a plan view of a connector with an auxiliary tool according to first embodiments.

FIG. 2 shows a perspective view in which a first housing is omitted in the connector with an auxiliary tool in FIG. 1.

FIG. 3 shows a side view in which a first housing is omitted in the connector with an auxiliary tool in FIG. 1.

FIG. 4 shows a sectional view taken along line IV-IV of FIG. 1.

FIG. 5 shows a perspective view of a second housing of FIG. 1.

FIG. 6 shows a perspective view of the first housing of FIG. 1.

FIG. 7 shows a sectional view taken along line VII-VII of FIG. 6.

FIG. 8 shows a view of the connector with an auxiliary tool of FIG. 1 as viewed from below.

FIG. 9 shows a view showing a state in which a plurality of connectors are collectively connected to an adapter using the auxiliary tool of FIG. 1.

FIG. 10 shows a view showing a state in which one of the plurality of connectors connected to the adapter is disconnected.

FIG. 11 shows a view showing a state in which a plurality of connectors are collectively connected to an adapter using an auxiliary tool of second embodiments.

FIG. 12]shows a view showing a state in which the plurality of connectors are collectively connected to the adapter using the auxiliary tool of the second embodiments.

FIG. 13 shows a view showing a state in which the plurality of connectors are collectively connected to the adapter using the auxiliary tool of the second embodiments.

FIG. 14 shows a view showing a state in which the plurality of connectors are collectively connected to the adapter using the auxiliary tool of the second embodiments.

FIG. 15 shows a view showing a state in which the plurality of connectors are collectively connected to the adapter using the auxiliary tool of the second embodiments.

FIG. 16 shows a view showing a state in which the plurality of connectors are collectively connected to the adapter using the auxiliary tool of the second embodiments.

FIG. 17 shows a perspective view of a first housing of FIG. 11.

FIG. 18 shows a perspective view of a second housing of FIG. 11.

FIG. 19 shows a sectional view taken along line V-V of FIG. 18.

FIG. 20 shows a perspective view showing a part of an optical connector of FIG. 11.

FIG. 21] a perspective view of a periphery of a pressing portion immediately before the pressing portion of one or more embodiments presses the connector.

FIG. 22 shows a perspective view of a periphery of a pressing portion when the pressing portion of one or more embodiments presses the connector.

FIG. 23 shows a view showing a state subsequent to FIG. 22.

FIG. 24 shows a perspective view of FIG. 19.

FIG. 25 shows a view for describing an operation of removing the connector with an auxiliary tool of one or more embodiments from the adapter.

### DETAILED DESCRIPTION

Hereinafter, an auxiliary tool and a connector with an auxiliary tool of one or more embodiments will be described with reference to the drawings.

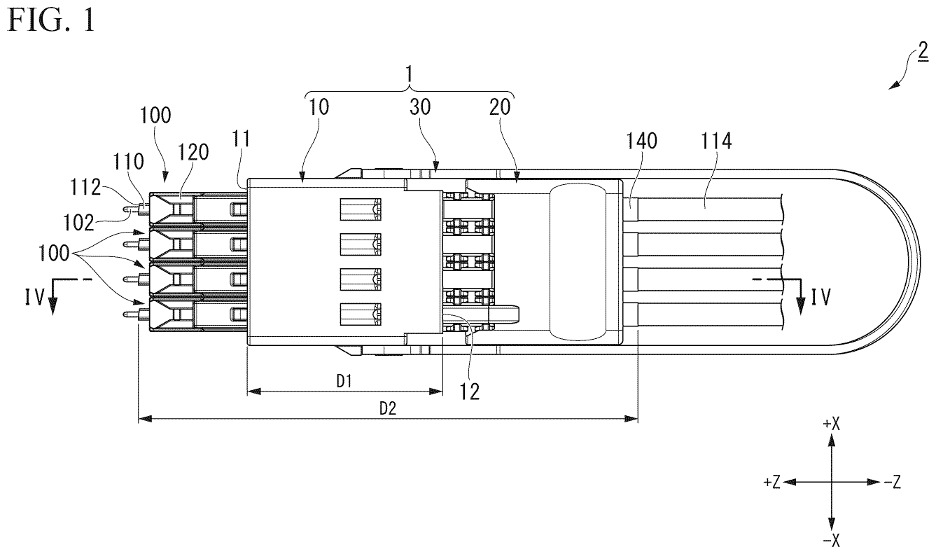

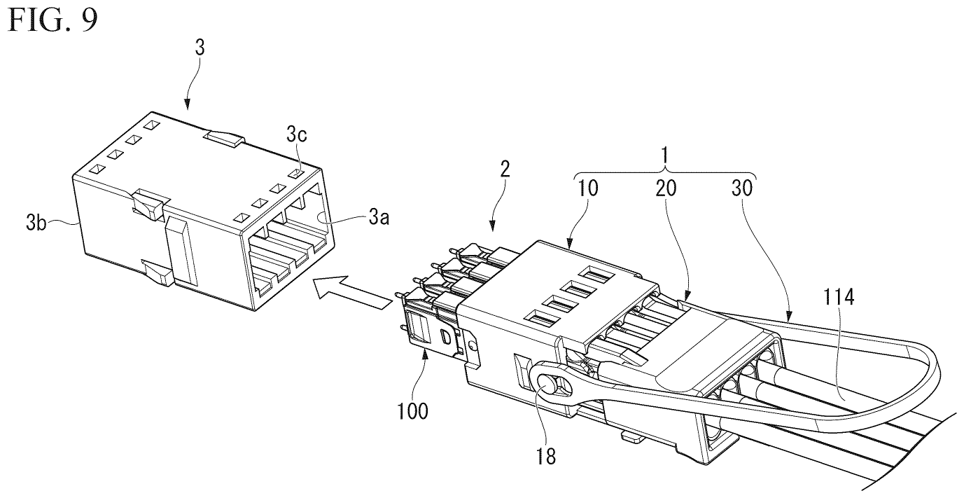

As shown in FIG. 1, the connector with an auxiliary tool 2 includes an auxiliary tool 1 and a plurality of connectors 100. The auxiliary tool 1 includes a first housing 10, a second housing 20, and a handle 30. The auxiliary tool 1 need not include the handle 30. The auxiliary tool 1 is configured to collectively connect and disconnect a plurality of connectors 100 to and from the adapter 3 (see FIG. 9). A patch panel (not shown) deployed in a data center or the like often has a large number of closely arranged adapters 3.

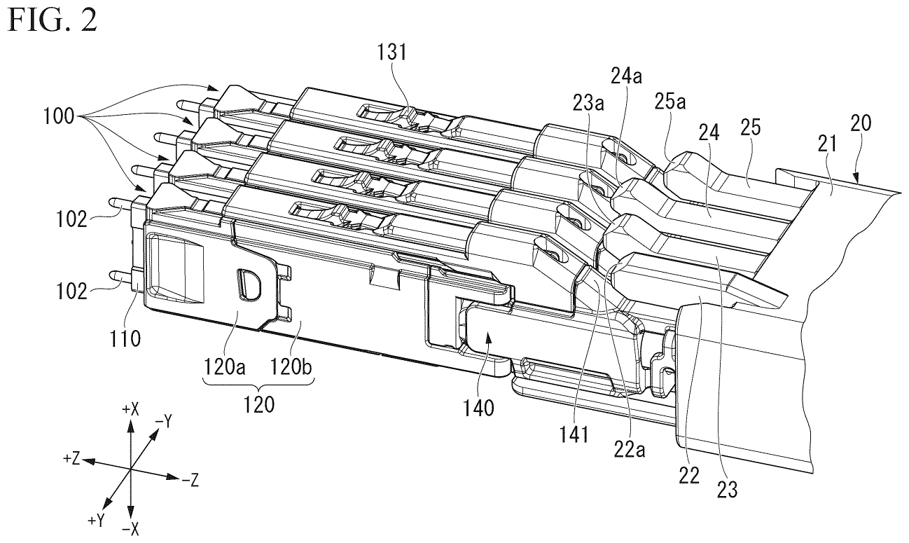

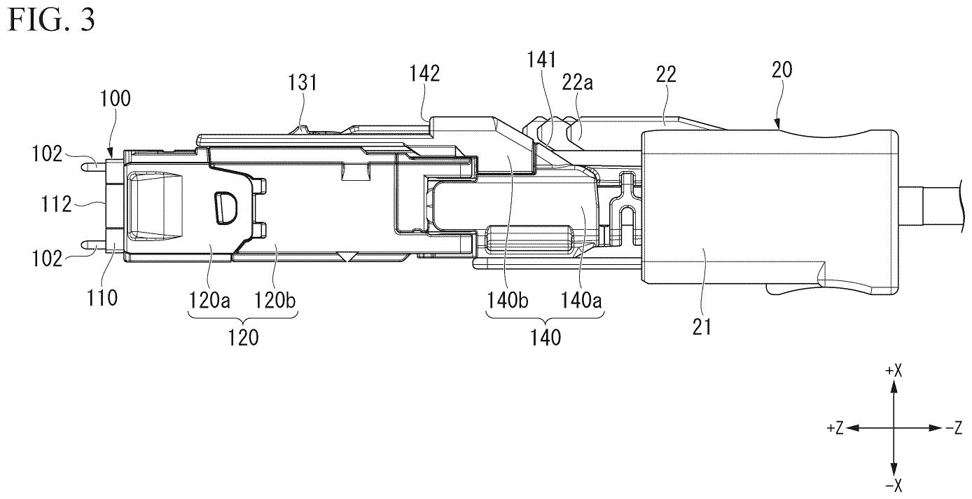

FIGS. 2 and 3 are views in which the first housing 10 is omitted in the connector with an auxiliary tool 2 of FIG. 1. As shown in FIGS. 2 and 3, each connector 100 includes a ferrule 110, a housing 120, an engagement protrusion 131, and a boot 140. The connector 100 of one or more embodiments is a male connector and has two positioning pins 102. The positioning pins 102 are inserted into positioning holes of a ferrule of a female connector (not shown) in the adapter 3. Accordingly, the two connectors are aligned at positions facing each other. The plurality of connectors 100 provided in the connector with an auxiliary tool 2 may be female connectors. That is, the connector 100 need not have the positioning pin 102.

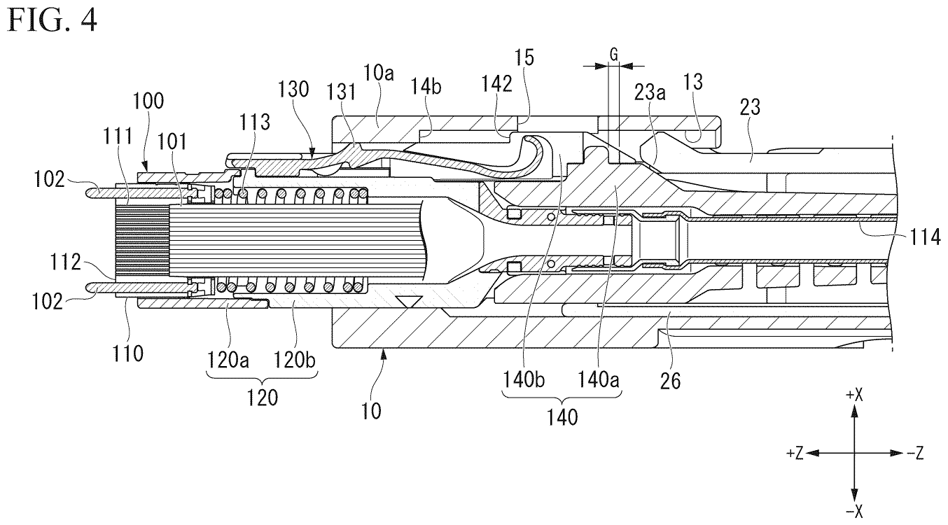

FIG. 4 is a sectional view taken along line IV-IV of FIG. 1. As shown in FIG. 4, the connector 100 includes a plurality of optical fibers 101. The ferrule 110 has a plurality of fiber holes 111. The optical fiber 101 is inserted into the fiber holes 111. The optical fiber 101 includes a glass part and a coating layer that covers the glass part. In the example of FIG. 4, the glass part is inserted into the fiber hole 111. A biasing member 113 that biases the ferrule 110 is disposed inside the housing 120. The biasing member 113 is, for example, a coil spring. The ferrule 110 has a connection end surface 112 on which the optical fiber 101 is exposed. The connection end surface 112 abuts the connection end surface of the other connector inside the adapter 3 due to the biasing force of the biasing member 113. As a result, the two connectors are optically connected.

### Definition of Direction

In one or more embodiments, the longitudinal direction of the optical fiber 101 will be simply referred to as a longitudinal direction Z. The longitudinal direction Z also coincides with the parallel direction in which the first housing 10 and the second housing 20 are arranged. One direction orthogonal to the longitudinal direction Z is referred to as a first direction X or an up-down direction X. The direction orthogonal to both the longitudinal direction Z and the first direction X is referred to as a second direction Y or a left-right direction Y. The direction in which the biasing member 113 biases the ferrule 110 along the longitudinal direction Z is referred to as a +Z direction, forward, or a distal end side. The direction opposite to the +Z direction is referred to as a −Z direction, rearward, or a proximal end side. One direction along the first direction X is referred to as a +X direction or an upper side. The direction opposite to the +X direction is referred to as a −X direction or a lower side. One direction along the second direction Y is referred to as a +Y direction or a left side. The direction opposite to the +Y direction is referred to as a −Y direction or a right side. However, the up-down direction X needs not coincide with the vertical direction. A case where the image is viewed in the up-down direction X is referred to as a plan view, and a case where the image is viewed in the left-right direction Y is referred to as a side view.

As shown in FIGS. 2, 3, and 5, the second housing 20 includes a second main body portion 21 and a plurality of pressing pieces 22 to 25. The second main body portion 21 has a tubular shape having a rectangular cross section extending in the longitudinal direction Z. A plurality of connectors 100 are inserted into the inside of the second main body portion 21. The pressing pieces 22 to 25 protrude from an upper end portion (an end portion on the +X side) of the second main body portion 21 to a distal end side (+Z side). The number of the pressing pieces 22 to 25 is equal to the number of the connectors 100 provided in the connector with an auxiliary tool 2. In one or more embodiments, the number of each of the pressing pieces 22 to 25 and the connector 100 is four. However, the number of the pressing pieces 22 to 25 and the number of the connectors 100 may be changed as long as the number is two or more. Hereinafter, each of the four pressing pieces may be referred to as a first pressing piece 22, a second pressing piece 23, a third pressing piece 24, and a fourth pressing piece 25.

The pressing pieces 22 to 25 are disposed side by side in the left-right direction Y. The plurality of connectors 100 are also arranged side by side in the left-right direction Y. Each of the pressing pieces 22 to 25 corresponds to one connector 100. Pressing portions 22a to 25a that are in contact with the corresponding connectors 100 are provided at the distal end portions (end portions on the +Z side) of each of the pressing pieces 22 to 25. The pressing portions 22a to 25a are portions that abut each connector 100 in a case where a plurality of connectors 100 are collectively connected to the adapter using the auxiliary tool 1. Here, the positions of the pressing portions 22a to 25a in the longitudinal direction Z are different from each other. Specifically, the pressing portion 24a of the third pressing piece 24 is located closest to the +Z side, and the pressing portion 23a of the second pressing piece 23 is located second closest to the +Z side. The pressing portion 25a of the fourth pressing piece 25 is located third closest to the +Z side, and the pressing portion 22a of the first pressing piece 22 is located fourth closest to the +Z side. However, the order of arrangement of the pressing portions 22a to 25a in the longitudinal direction Z can be changed.

As shown in FIG. 3 and the like, the boot 140 of each of the connectors 100 has a first abutting surface 141 and a second abutting surface 142. Each of the first abutting surfaces 141 faces the pressing portions 22a to 25a in the longitudinal direction Z. Each of the second abutting surfaces 142 faces the release portions 14a to 14d (described below) in the longitudinal direction Z. In a case where the connection operation is performed, the pressing portions 22a to 25a come into contact with each of the first abutting surfaces 141, and thus the connector 100 is pushed toward the adapter 3. In one or more embodiments, the first abutting surface 141 is inclined upward toward the distal end side. The end surfaces of the pressing portions 22a to 25a are also inclined in accordance with the inclination of the first abutting surface 141.

As shown in FIG. 4, the connector 100 includes an elastic piece 130. The engagement protrusion 131 is a part of the elastic piece 130. However, the engagement protrusion 131 may be a part of another member (the housing 120, the boot 140, and the like) provided in the connector 100. The elastic piece 130 is formed of, for example, a leaf spring and has elasticity. The engagement protrusion 131 has a function of entering an inside of an engagement hole 3c (see FIG. 9) of the adapter 3 to engage the connector 100 with the adapter 3. The boot 140 includes two members (a boot main body 140a and a movable member 140b). A holding space that holds the elastic piece 130 is formed inside the movable member 140b.

Although not shown in FIG. 4, each optical fiber 101 passes through the inside of the connector 100 and extends from the boot 140 to the proximal end side (−Z side). The optical fiber 101 extending in this way is accommodated inside an outer jacket 114 shown in FIGS. 1 and 4. A tension member or the like may be disposed inside the outer jacket 114 in addition to the plurality of optical fibers 101. The outer jacket 114 and the plurality of optical fibers 101 are collectively referred to as an “optical cord” in some cases.

The movable member 140b is movable in the longitudinal direction Z with respect to the boot main body 140a within a range of a gap G shown in FIG. 4. With this configuration, in a case where the optical cord is pulled or bent, the force is suppressed from being directly transmitted to the elastic piece 130. Therefore, it is possible to suppress the disengagement of the engagement protrusion 131 from the engagement hole 3c, that is, the disengagement of the connector 100 and the adapter 3.

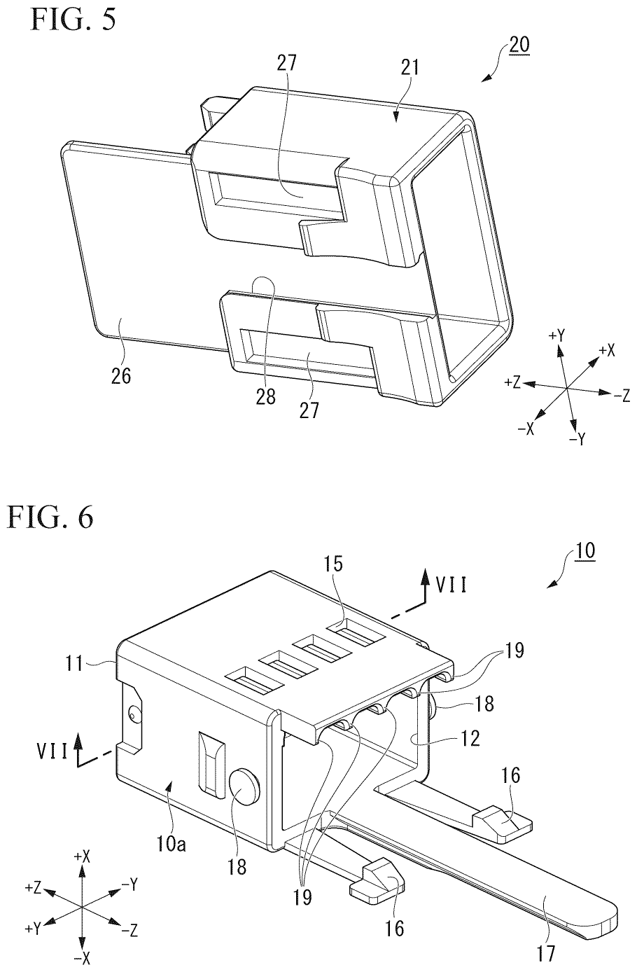

As shown in FIG. 5, the second housing 20 has an entrance portion 26. The entrance portion 26 protrudes from a lower end portion (an end portion on the −X side) of the second main body portion 21 to the distal end side (+Z side). The entrance portion 26 has a plate shape and extends in the left-right direction Y and the longitudinal direction Z. As shown in FIG. 4, the entrance portion 26 enters a gap between the first housing 10 and the boot 140 inside the first housing 10. Accordingly, the gap in the up-down direction X between the first housing 10 and the boot 140 is filled. With this configuration, the gap is generated between the boot 140 and the first housing 10 until the second housing 20 is combined with the first housing 10. Therefore, it is easy to insert the connector 100 into the inside of the first housing 10. In addition, after the second housing is combined with the first housing 10, the gap is filled with the entrance portion 26, and thus the relative movement between the first housing 10 and the connector 100 can be suppressed.

As shown in FIG. 5, the second main body portion 21 is formed with two locking recess portions 27 and one guide recess portion 28. The locking recess portion 27 and the guide recess portion 28 are formed on a surface of the second main body portion 21 facing the lower side (−X side). The two locking recess portions 27 are disposed at intervals in the left-right direction Y. The guide recess portion 28 is positioned between the two locking recess portions 27 in the left-right direction Y. The guide recess portion 28 extends in the longitudinal direction Z. The width of the guide recess portion 28 in the left-right direction Y increases toward the upper side (+X side).

As shown in FIG. 6, the first housing 10 includes a first main body portion 10a, two locking protruding portions 16, one guide protruding portion 17, and a pressing piece guide rail 19. The first main body portion 10a has a tubular shape having a rectangular cross section extending in the longitudinal direction Z. The first main body portion 10a has a first opening 11 facing the distal end side and a second opening 12 facing the proximal end side. As shown in FIG. 1, a plurality of connectors 100 protrude from the first opening 11. The second opening 12 faces the second housing 20. As shown in FIG. 6, the locking protruding portion 16 and the guide protruding portion 17 protrude from a lower end portion (end portion on the −X side) of the first main body portion 10a toward the proximal end side (−Z side). The two locking protruding portions 16 are disposed at intervals in the left-right direction Y. The guide protruding portion 17 is positioned between the two locking protruding portions 16 in the left-right direction Y. The guide protruding portion 17 extends in the longitudinal direction Z. The width of the guide protruding portion 17 in the left-right direction Y increases toward the upper side (+X side). The pressing piece guide rails 19 restrict the intrusion direction of the pressing pieces 22 to 25 of the second housing. Therefore, the pressing pieces 22 to 25 can appropriately apply the pressing force to the connector 100.

The mounting portion 18 is formed on each of both side surfaces of the first main body portion 10a (a surface facing the +Y side and a surface facing the −Y side). The mounting portions 18 are used for attaching the handle 30 (see FIGS. 1 and 9) to the first housing 10. The handle 30 has a U-shape as viewed in the up-down direction X. The handle 30 is rotatable about the two mounting portions 18. Therefore, the user can rotate the handle 30 with respect to the first housing 10 such that the handle 30 is at an angle at which the handle 30 is easy to handle.

A distance D1 shown in FIG. 1 is a distance in the longitudinal direction Z from the first opening 11 to the second opening 12. In other words, the distance D1 is a dimension of the first main body portion 10a in the longitudinal direction Z. A distance D2 shown in FIG. 1 is a distance in the longitudinal direction Z from the connection end surface 112 of the ferrule 110 to the rear end of the boot 140 (end portion on the −Z side). The distance D1 is shorter than the distance D2. Therefore, in a state where the connector 100 is inserted into the first housing 10, at least a part of the ferrule 110 and a part of the boot 140 can be positioned outside the first housing 10.

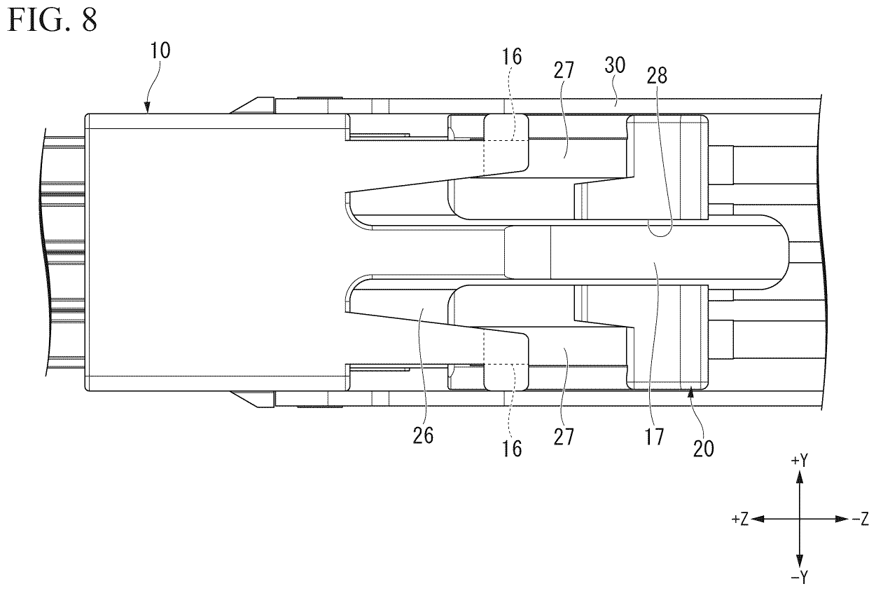

As shown in FIG. 8, in a state in which the first housing 10 and the second housing 20 are combined, the guide protruding portion 17 enters the inside of the guide recess portion 28. In addition, the two locking protruding portions 16 are each inserted into the two locking recess portions 27. Here, the widths of the guide protruding portions 17 and the guide recess portions 28 in the left-right direction Y increase toward the upper side. Therefore, the guide protruding portion 17 is suppressed from falling off from the guide recess portion 28 downward. In other words, the relative position of the first housing 10 and the second housing 20 in the up-down direction X is determined. In this state, the first housing 10 and the second housing 20 can move relative to each other in the longitudinal direction Z. In a case of the relative movement, the guide protruding portion 17 and the guide recess portion 28 slide with respect to each other, and the locking protruding portion 16 and the locking recess portion 27 slide with respect to each other.

As shown in FIG. 5, the two locking recess portions 27 of the second housing 20 have a form in which the both end portions in the longitudinal direction Z are closed. Therefore, in a case where the first housing 10 and the second housing 20 are to be moved relative to each other beyond the range of the length of the locking recess portion 27 in the longitudinal direction Z, the locking protruding portion 16 abuts an end portion of the locking recess portion 27. That is, the locking protruding portions 16 and the locking recess portions 27 regulate the relative movement of the first housing 10 and the second housing 20 in the longitudinal direction Z within a certain range. As described above, the locking protruding portion 16 and the locking recess portion 27 have a function of maintaining a state in which the first housing 10 and the second housing 20 are combined. However, for example, the first housing 10 and the second housing 20 can also be separated from each other by elastically deforming the locking protruding portion 16 downward to release the locking with respect to the locking recess portion 27.

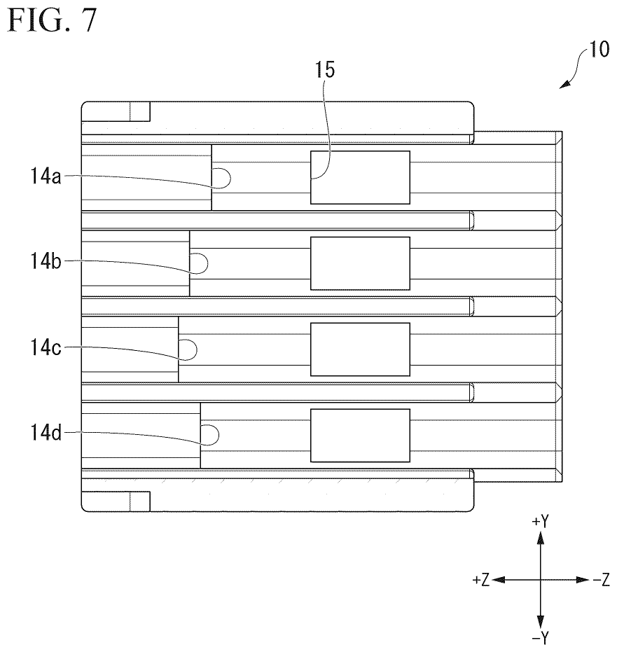

As shown in FIG. 6, the first housing 10 is formed with the same number of avoidance holes 15 (four in the embodiments shown in FIG. 6) as the number of the connectors 100. Each avoidance hole 15 penetrates an upper wall (a wall portion facing upward) of the first main body portion 10a in the up-down direction X. The avoidance holes 15 are disposed at intervals in the left-right direction Y. FIG. 7 is a sectional view taken along line VII-VII of FIG. 6. As shown in FIG. 7, the same number of (four in the embodiments shown in FIG. 7) release portions 14a to 14d as the number of the connector 100 are formed (provided) inside the first main body portion 10a. The release portions 14a to 14d have a function of releasing the connection of the connector 100 to the adapter 3. Each of the release portions 14a to 14d is a surface facing the proximal end side (−Z side). The release portions 14a to 14d are each disposed at intervals in the left-right direction Y. Each of the release portions 14a to 14d corresponds to one connector 100. Hereinafter, these release portions may be referred to as a first release portion 14a, a second release portion 14b, a third release portion 14c, and a fourth release portion 14d.

The release portions 14a to 14d are located on the distal end side (+Z side) with respect to the avoidance hole 15. The positions of the release portions 14a to 14d in the longitudinal direction Z are different from each other. Specifically, the first release portion 14a is located first closest to the −Z side, and the fourth release portion 14d is located second closest to the −Z side. The second release portion 14b is located third closest to the −Z side, and the third release portion 14c is located fourth closest to the −Z side. However, the order of arrangement of the release portions 14a to 14d in the longitudinal direction Z can be changed. FIG. 4 shows a vertical cross section (cross section along the up-down direction X and the longitudinal direction Z) including the second release portion 14b. Although not shown, vertical cross sections corresponding to the release portions 14a to 14d are the same as each other except that the positions of the release portions 14a to 14d and the pressing portions 22a to 25a in the longitudinal direction Z are different. The first main body portion 10a has a contact surface 13 facing downward. The contact surface 13 is located inside the first main body portion 10a and comes into contact with each of the pressing portions 22a to 25a in a case where the connection operation is performed.

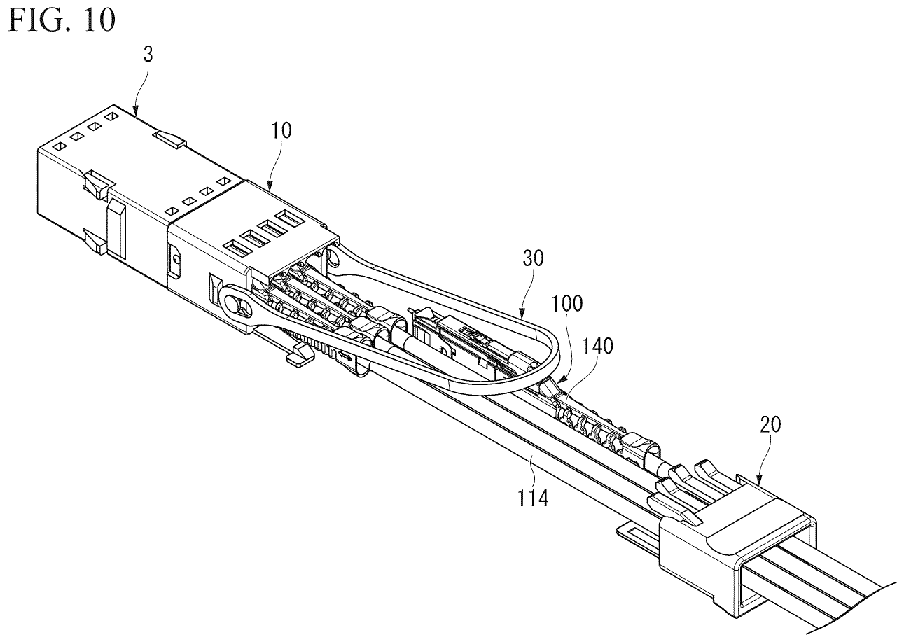

Next, the actions of the auxiliary tool 1 and the connector with an auxiliary tool 2, which are configured as described above, will be described with reference to FIGS. 9 and 10. In FIGS. 9 and 10, only one adapter 3 is shown, but in an actual data center or the like, a large number of adapters 3 are densely disposed on a patch panel. In addition, although the connector on the other side is not shown in FIGS. 9 and 10, the connector on the other side may be connected to the adapter 3 from the second insertion port 3b.

### Connection Operation

In a case where the connection operation is performed, as shown in FIG. 9, the connector with an auxiliary tool 2 is brought close to the adapter 3. More specifically, the plurality of connectors 100 are allowed to enter the first insertion port 3a of the adapter 3 by gripping the second housing 20. In a case where the connector 100 enters the first insertion port 3a to some extent, the first housing 10 comes into contact with the adapter 3. Further, in a case where the second housing 20 is pushed toward the adapter 3, the second housing 20 is moved to the distal end side (+Z side) with respect to the first housing 10. In this case, the guide protruding portion 17 and the guide recess portion 28 slide with respect to each other, and the relative movement of the first housing 10 and the second housing 20 is guided (see FIGS. 5 to 7).

The pressing pieces 22 to 25 enter the first main body portion 10a toward the distal end side as the second housing 20 and the first housing 10 are moved relative to each other. In this case, the third pressing portion 24a located on the most distal end side among the plurality of pressing portions 22a to 25a abuts the first abutting surface 141 of the connector 100 first. At this point, the first pressing portion 22a, the second pressing portion 23a, and the fourth pressing portion 25a are separated from the first abutting surface 141 of each connector 100. That is, only one third pressing portion 24a presses the connector 100 toward the distal end side. In this case, the pressing pieces 22 to 25 are restricted in the sliding direction to one direction (pressing direction) by the pressing piece guide rail 19 of the first housing 10, and the dispersion of the pressing force is suppressed. The operation force applied by the user is substantially the same as a force in a case where one connector 100 is pushed into the adapter 3.

Since the first abutting surface 141 is inclined, a component force is applied to the third pressing portion 24a in an upward direction during the connection operation. In this case, since the contact surface 13 is in contact with the third pressing portion 24a, the third pressing portion 24a is suppressed from being deformed upward (see FIG. 4). Therefore, the connector 100 can be reliably pushed to the distal end side by the third pressing portion 24a.

In a case where the third pressing portion 24a pushes the connector 100 by a predetermined amount, the engagement protrusion 131 of the connector 100 is engaged with the engagement hole 3c of the adapter 3. As a result, the connection between the connector 100 and the adapter 3 is completed. After that, the user continues to push the second housing 20 toward the adapter 3. Accordingly, the second pressing portion 23a that is located second closest to the distal end side among the plurality of pressing portions 22a to 25a abuts the first abutting surface 141 of the connector 100. Then, the second pressing portion 23a pushes the connector 100, so that the engagement protrusion 131 and the engagement hole 3c are engaged with each other.

At the same time as the second pressing portion 23a pushes the connector 100, the third pressing portion 24a enters the avoidance hole 15 of the first housing 10. Therefore, even in a case where the second housing 20 is pushed in, a force with which the third pressing portion 24a pushes in the connector 100 is not generated or is reduced. Therefore, the operation force for the user to push the second housing 20 is also reduced.

Thereafter, the fourth pressing portion 25a and the first pressing portion 22a also push the corresponding connector 100 toward the distal end side in order. That is, the four connectors 100 can be collectively connected to the adapter 3 by one operation of pushing the second housing 20. In addition, for example, in a case where four connectors 100 are connected at the same time, the required operation force is four times or more the operation force in a case where one connector 100 is connected. However, in one or more embodiments, the plurality of pressing portions 22a to 25a connect each of the connectors 100 at different timings. Therefore, the operation force required for the collective connection operation is reduced.

Next, the disconnection operation will be described. According to the auxiliary tool 1 of one or more embodiments, two types of disconnection operations, that is, a collective disconnection operation and an individual disconnection operation can be performed. According to the collective disconnection operation, the plurality of connectors 100 can be collectively disconnected from the adapter 3. According to the individual disconnection operation, one of the plurality of connectors 100 can be selectively disconnected from the adapter 3. Hereinafter, each will be described.

### Collective Disconnection Operation

The first housing 10 is pulled to the proximal end side (−Z side) from a state in which the plurality of connectors 100 are connected to the adapter 3. In this case, the user may grip the first housing 10 or may grip the handle 30. In a case where the first housing 10 is moved to the proximal end side with respect to the adapter 3, the first release portion 14a located on the most proximal end side among the plurality of release portions 14a to 14d abuts the second abutting surface 142 of the corresponding connector 100 earliest. The first release portion 14a pushes the second abutting surface 142 toward the proximal end side, and thus a force directed toward the proximal end side is applied to the connector 100. Accordingly, the engagement between the engagement protrusion 131 and the engagement hole 3c is released, and the connection of one connector 100 to the adapter 3 is released.

Further, in a case where the first housing 10 is moved to the proximal end side, the fourth release portion 14d located second closest to the proximal end side abuts the second abutting surface 142 of the corresponding connector 100. Then, the fourth release portion 14d pushes the connector 100 to the proximal end side, so that the connector 100 is disconnected. After, the remaining connectors 100 are disconnected from the adapter 3 in order. That is, the four connectors 100 can be collectively disconnected from the adapter 3 by one operation of pulling the first housing 10. In addition, for example, in a case where the four connectors 100 are disconnected at the same time, the required operation force is four times or more the operation force in a case where one connector 100 is disconnected. However, in one or more embodiments, the plurality of release portions 14a to 14d disconnect the connection of each connector 100 at different timings. Therefore, the operation force required in the case of the collective disconnection operation is reduced.

### Individual Disconnection Operation

For example, in the maintenance work or the like, only part of the plurality of connectors 100 may be disconnected from the adapter 3. A method of operating the auxiliary tool 1 in such a case will be described. First, the second housing 20 is pulled to the proximal end side with respect to the first housing 10. In this case, since the locking protruding portion 16 of the first housing 10 abuts the end portion of the locking recess portion 27 of the second housing 20, the movement of the second housing 20 toward the proximal end side is restricted. Next, for example, the locking protruding portion 16 is elastically deformed downward to release the locking with respect to the locking recess portion 27. Accordingly, the second housing 20 can be further moved to the proximal end side.

As shown in FIG. 1, the distance D1 is shorter than the distance D2. Therefore, as shown in FIG. 10, in a case where the second housing 20 is sufficiently moved to the proximal end side, the boot 140 of each of the connectors 100 is exposed. Therefore, by gripping the boot 140 of any connector 100 and pulling the boot 140 toward the proximal end side, any connector 100 can be disconnected from the adapter 3. As described above, the auxiliary tool 1 is configured to be able to perform both the collective disconnection operation and the individual disconnection operation.

As described above, the auxiliary tool 1 of one or more embodiments includes the first housing 10 and the second housing 20. The first housing 10 has a first opening 11 through which a plurality of connectors 100 protrude toward the adapter 3, and a second opening 12 that faces the second housing 20. The second housing 20 has a plurality of pressing portions 22a to 25a that enter the inside of the first housing 10 from the second opening 12 and press the plurality of connectors 100. A plurality of release portions 14a to 14d each of which abuts the respective one of the plurality of connectors 100 are formed (provided) inside the first housing 10 in a case where the first housing 10 is separated from the adapter 3. With such an auxiliary tool 1, the second housing 20 is pushed toward the adapter 3, such that the plurality of pressing portions 22a to 25a press the plurality of connectors 100 against the adapter 3. Accordingly, each connector 100 can be connected to the adapter 3. Further, the first housing 10 is separated from the adapter 3, such that the plurality of release portions 14a to 14d press the plurality of connectors 100 toward the proximal end side. Accordingly, the connector 100 can be pulled out from the adapter 3. That is, according to the auxiliary tool 1, it is possible to assist both the connection operation and the disconnection operation.

In addition, in a parallel direction (longitudinal direction Z) in which the first housing 10 and the second housing 20 are arranged, the positions of the plurality of pressing portions 22a to 25a are different from each other. Therefore, in a case of the connection operation, a timing at which the pressing portions 22a to 25a press the connector 100 to the distal end side is shifted. As a result, it is possible to reduce the operation force in a case where the user pushes the second housing 20.

In addition, in a parallel direction (longitudinal direction Z) in which the first housing 10 and the second housing 20 are arranged, the positions of the plurality of release portions 14a to 14d are different from each other. Therefore, in the collective disconnection operation, a timing at which the release portions 14a to 14d press the connector 100 to the proximal end side is shifted. As a result, it is possible to reduce the operation force in a case where the user pulls the first housing 10.

In addition, in a case where the plurality of pressing portions 22a to 25a press the plurality of connectors 100, the first housing 10 includes a contact surface 13 that is in contact with the plurality of pressing portions 22a to 25a, and a plurality of avoidance holes 15 that are formed (provided) in the contact surface 13 and into which the plurality of pressing portions 22a to 25a enter after the plurality of pressing portions 22a to 25a connect the plurality of connectors 100 to the adapter 3. According to this configuration, in a case where the pressing portions 22a to 25a press the connector 100, the pressing portions 22a to 25a come into contact with the contact surface 13, whereby the deformation of the pressing pieces 22 to 25 is suppressed. Therefore, the pressing portions 22a to 25a can more reliably press the connector 100. In addition, after the connector 100 is connected to the adapter 3, the pressing portions 22a to 25a enter the avoidance hole 15, and the pressing against the connector 100 is released. Therefore, it is possible to suppress an increase in the operation force in a case where the user pushes the second housing 20.

In addition, the auxiliary tool 1 includes a handle 30 attached to the first housing 10. Therefore, in a case where the disconnection operation is performed, the first housing 10 can be pulled to the proximal end side by pulling the handle 30. In particular, in a case where a large number of connectors 100 are densely present in a data center or the like, it may be difficult to grip the first housing 10. Even in such a case, by using the handle 30, it is possible to perform the disconnection operation without gripping the first housing 10.

In addition, the connector with an auxiliary tool 2 of one or more embodiments includes the auxiliary tool 1 and a plurality of connectors 100 inserted into the first housing 10 and the second housing 20. Each of the connectors 100 includes a plurality of optical fibers 101, a ferrule 110 having a plurality of fiber holes 111 into which the plurality of optical fibers 101 are inserted, a housing 120 that holds the ferrule 110, an engagement protrusion 131 that engages with the engagement hole 3c of the adapter 3, and a boot 140 that is located at an end portion of the connector 100 on a side opposite to the ferrule 110. According to the connector with an auxiliary tool 2, the first housing 10 is gripped and the plurality of connectors 100 are inserted into the first insertion port 3a of the adapter 3, whereby the engagement protrusion 131 of each of the connectors 100 can be engaged with the engagement holes 3c. Accordingly, the position of the connector 100 with respect to the adapter 3 is determined. In a case where a connector to be connected is inserted into the second insertion port 3b of the adapter 3, optical connection between the connectors is performed inside the adapter 3.

In addition, in a parallel direction (longitudinal direction Z) in which the first housing 10 and the second housing 20 are arranged, a distance D1 from the first opening 11 to the second opening 12 is shorter than a distance D2 from the connection end surface 112 of the ferrule 110 to the rear end of the boot 140. Therefore, at least a part of the ferrule 110 can be positioned in the adapter 3, and the boot 140 can be positioned outside the first housing 10. Further, the second housing 20 is movable to be separated from the first housing 10 toward the proximal end side until the boot 140 is exposed. According to the above structure, the user can grip the boot 140 by moving the second housing 20 to expose the boot 140. For example, in a case where only one connector 100 of the four connectors 100 is desired to be disconnected, only one boot 140 may be gripped and pulled toward the proximal end side without operating the first housing 10. Alternatively, in a case where all of the four connectors 100 are desired to be disconnected, the first housing 10 may be pulled to the proximal end side. In this way, it is possible to improve convenience in a case of performing the disconnection operation.

A technical scope of the present invention is not limited to the above-described embodiments, and various modifications can be made without departing from a spirit of the present invention.

For example, in one or more embodiments, the number of each of the connector 100, the pressing pieces 22 to 25, the release portions 14a to 14d, the avoidance hole 15, and the like is four. However, these numbers can be changed, and may be two, three, or five or more.

In addition, in one or more embodiments, the positions of the plurality of release portions 14a to 14d in the longitudinal direction Z are different. However, even in a case where the positions of the release portions 14a to 14d in the longitudinal direction Z are the same, it is possible to perform the collective connection operation and the collective disconnection operation by using the auxiliary tool 1. Therefore, it is not essential that the positions of the plurality of release portions 14a to 14d in the longitudinal direction Z are different from each other. Similarly, it is not essential that the positions of the plurality of pressing portions 22a to 25a in the longitudinal direction Z are different.

It is possible to replace configurations of the above embodiments with any known configurations without departing from the scope of the invention. It is also possible to properly combine above embodiments and modification examples.

### Second Embodiments

Next, an auxiliary tool 1B and a connector with an auxiliary tool 2B according to second embodiments of the present invention will be described with reference to the drawings. The same reference numerals are assigned to the same configurations as those in the first embodiments, the description thereof will be omitted, and only the difference from the auxiliary tool 1 and the connector with an auxiliary tool 2 of the first embodiments will be described.

The auxiliary tool 1B of the second embodiments is different from the auxiliary tool 1 of the first embodiments in that the first housing 210 and the second housing 220 have different shapes. Therefore, the mechanism in a case where the connection operation is performed is different from a case where the auxiliary tool 1 according to the first embodiments is used.

In order to facilitate understanding, an outline of a movement of connecting the plurality of connectors 100 to the adapter 3 using the auxiliary tool 1B will be described first.

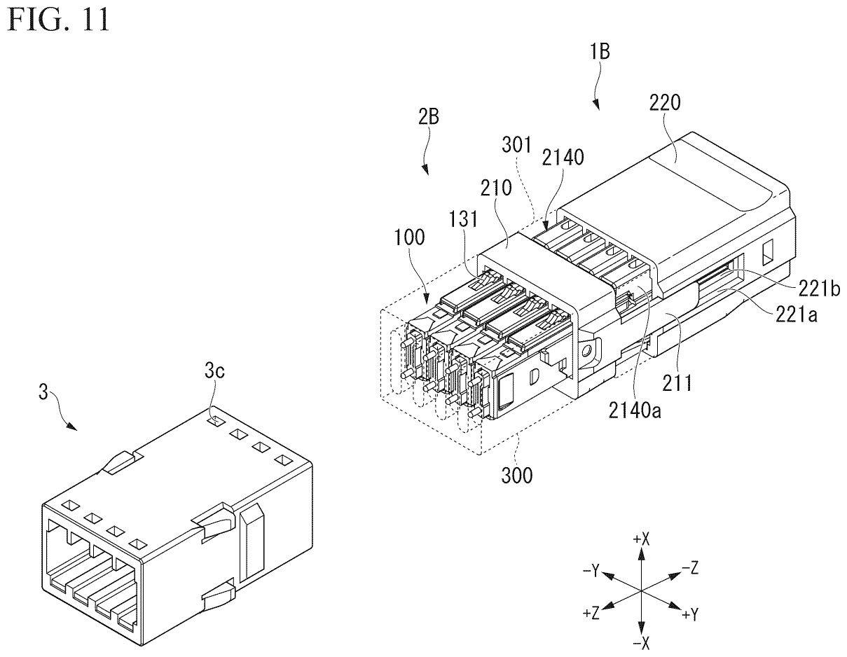

FIG. 11 shows a state before the connector with an auxiliary tool 2B is brought close to the adapter 3. At this point, a cap 300 is put on the plurality of connectors 100. The cap 300 is a member that protects a portion where the plurality of connectors 100 are exposed to the outside, and is formed of a resin or the like. In addition, a protective spacer 301 is provided between the first housing 210 and the second housing 220. The protective spacer 301 is a member that keeps a distance between the first housing 210 and the second housing 220 constant, and is formed of a resin or the like.

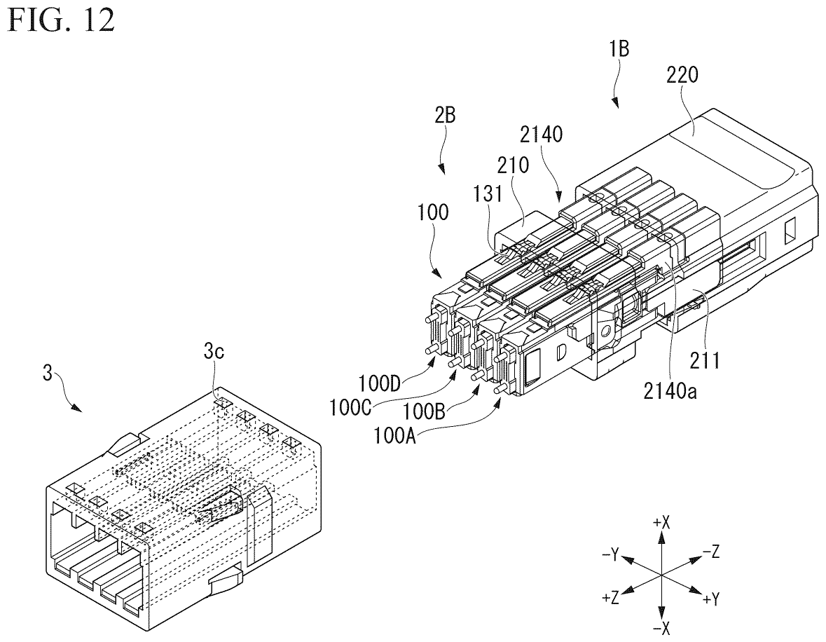

FIG. 12 shows a state in which the plurality of connectors 100 are exposed by removing the cap 300 and the protective spacer 301, and the protective spacer 301 is not present between the first housing 210 and the second housing 220. In the following description, the plurality of connectors 100 are referred to as a connector 100A, a connector 100B, a connector 100C, and a connector 100D from the −Y side toward the +Y side. In the example shown in the drawing, the number of connectors 100 is four, but the number of connectors 100 is not limited to four.

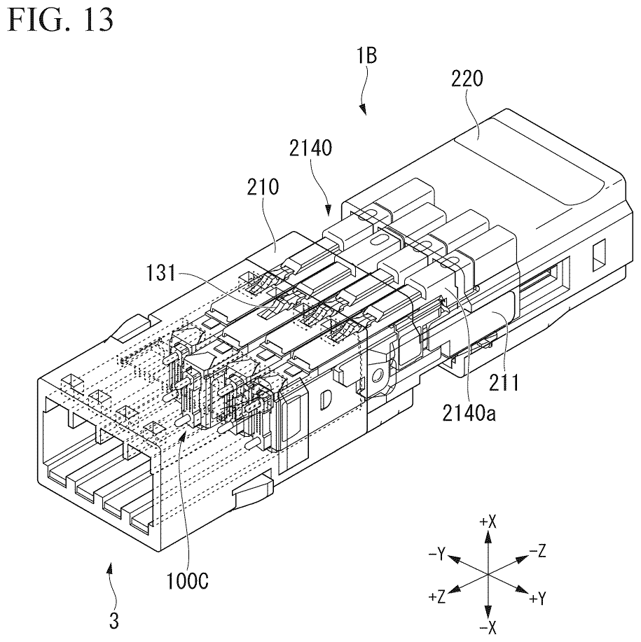

FIG. 13 shows a state in which the second housing is moved in the +Z direction from the state of FIG. 12. In this case, any one of pressing portions 222 to 225, which will be described later, provided in the second housing 220 presses the connector 100 in the +Z direction one by one. Accordingly, the connector 100 is moved one by one in the +Z direction, and the engagement protrusion 131 of the connector 100 enters the inside of the engagement hole 3c of the adapter 3 to engage the connector 100 with the adapter 3. FIG. 13 shows a state in which the connector 100C is engaged with the adapter 3 by the engagement protrusion 131 of the connector 100C entering the inside of the engagement hole 3c of the adapter 3.

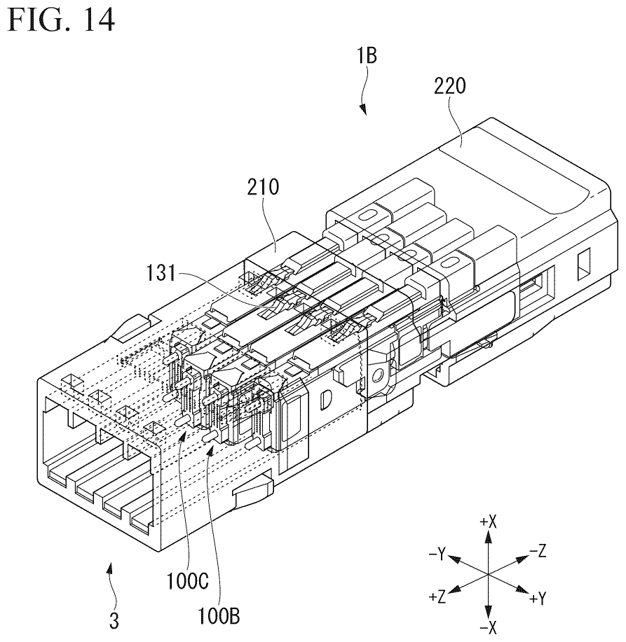

FIG. 14 shows a state in which the connector 100B is further entered the inside of the engagement hole 3c of the adapter 3 from the state of FIG. 13 and the connector 100B is engaged with the adapter 3.

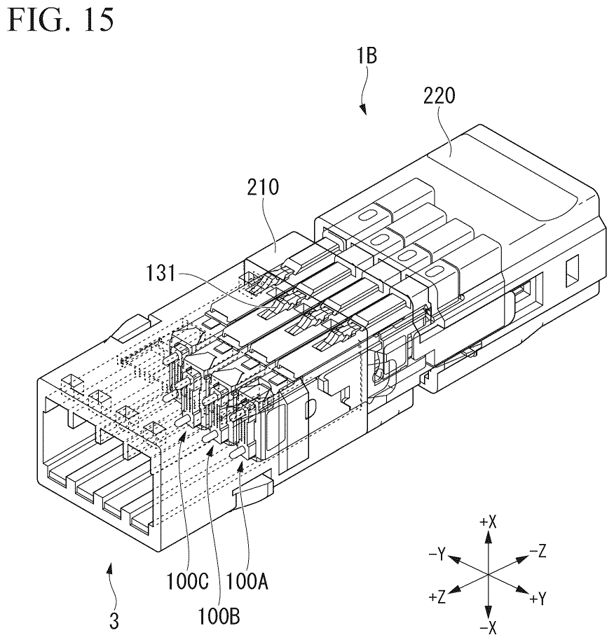

FIG. 15 shows a state in which the connector 100A is further entered the inside of the engagement hole 3c of the adapter 3 from the state of FIG. 14 and the connector 100A is engaged with the adapter 3.

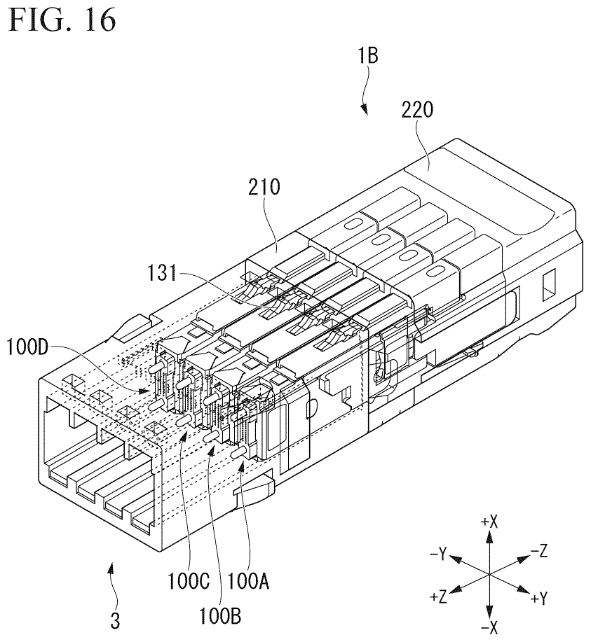

FIG. 16 shows a state in which the connector 100D is further entered the inside of the engagement hole 3c of the adapter 3 from the state of FIG. 15 and the connector 100D is engaged with the adapter 3 and all the connectors 100 are engaged with the adapter 3.

Hereinafter, a configuration for implementing the above-described operation will be described in detail.

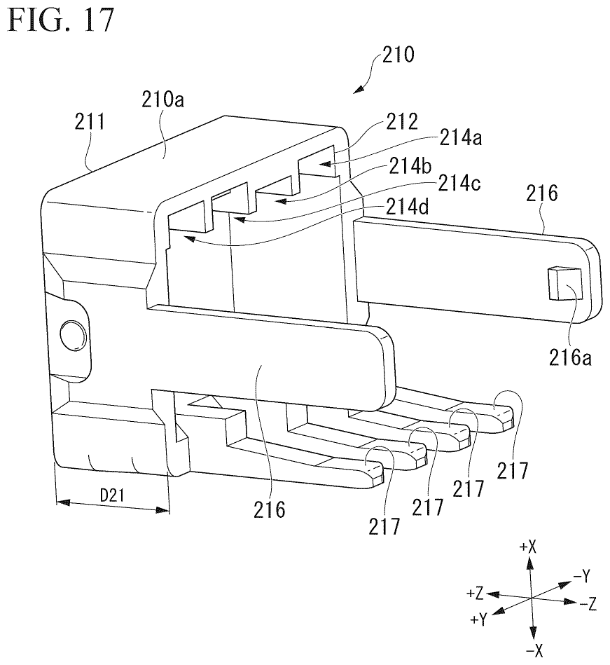

As shown in FIG. 17, the first housing 210 includes a first main body portion 210a, a first opening 211, a second opening 212, two locking portions 216, and a plurality of engagement release portions 217. The first opening 11 faces the distal end side. A plurality of the connectors 100 protrude in the +Z direction from the first opening 11. The second opening 12 faces the second housing 20. The plurality of engagement release portions 217 are provided at a lower end portion of the first housing 210. The number of the engagement release portions 217 is the same as the number of the connectors 100 (four in the embodiments shown in FIG. 17) to be mounted on the auxiliary tool 1. The engagement release portion 217 extends from the second opening 212 to the proximal end side. The two locking portions 216 extend from both side surfaces of the first housing 210 (surfaces facing the +Y side and the −Y side) to the proximal end side. The locking protrusions 216a are provided at end portions of the two locking portions 216 on the −Z direction side to protrude from both side surfaces of the first housing 210 toward the center of the first housing 210.

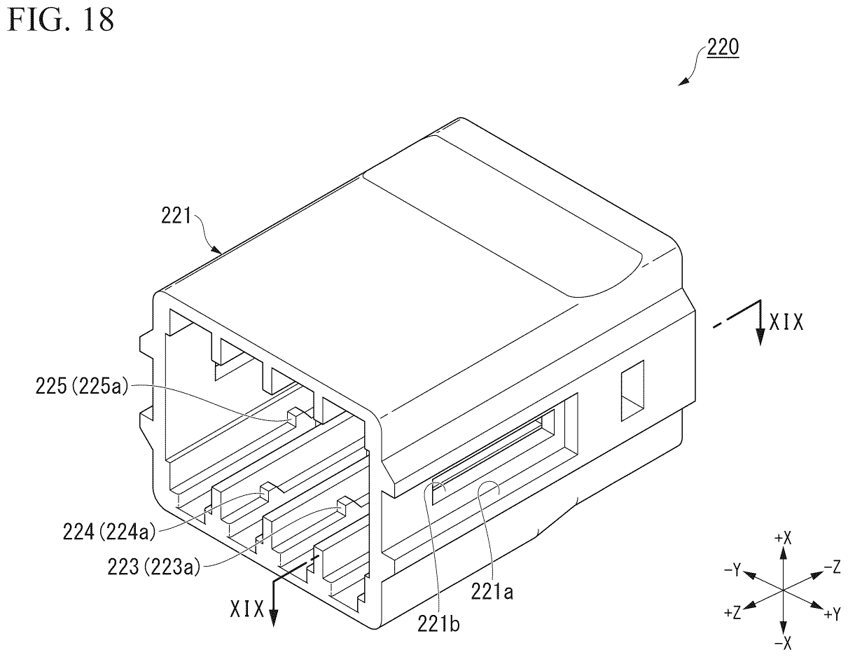

As shown in FIG. 18, the second housing 220 includes a second main body portion 221 and a plurality of pressing portions 222 to 225. The second main body portion 221 has a tubular shape that extends in the longitudinal direction Z and has a rectangular cross section. A plurality of connectors 100 are inserted into the inside of the second main body portion 221. Two guide grooves 221a are formed in the second main body portion 221. The guide groove 221a is recessed inward in the left-right direction Y of the second main body portion 221 from both side surfaces of the second main body portion 221 (surfaces facing the +Y side and the −Y side). The guide groove 221a extends linearly from an end portion of the second main body portion 221 in the +Z direction toward the −Z direction. A locking hole 221b is formed in an inner surface of each guide groove 221a. The locking hole 221b penetrates the second main body portion 221 in the left-right direction Y. The locking hole 221b extends in the longitudinal direction Z inside the guide groove 221a.

In a state in which the first housing 210 and the second housing 220 are combined, the locking portion 216 of the first housing 210 enters the guide groove 221a of the second housing 220. Further, the locking protrusion 216a enters the locking hole 221b. In a case where the first housing 210 and the second housing 220 move relative to each other in the longitudinal direction Z, the locking portion 216 and the guide groove 221a slide with respect to each other. Since the locking protrusion 216a is in the locking hole 221b, the first housing 210 is restricted from moving to the distal end side with respect to the second housing 220 beyond a predetermined range.

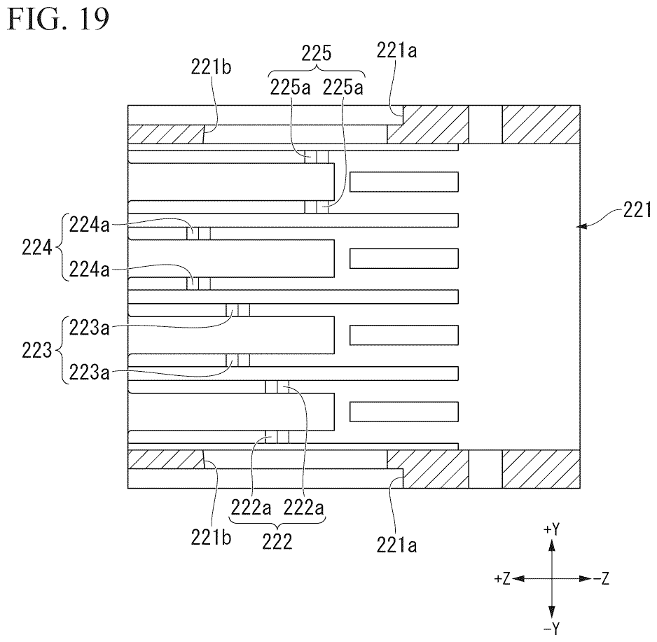

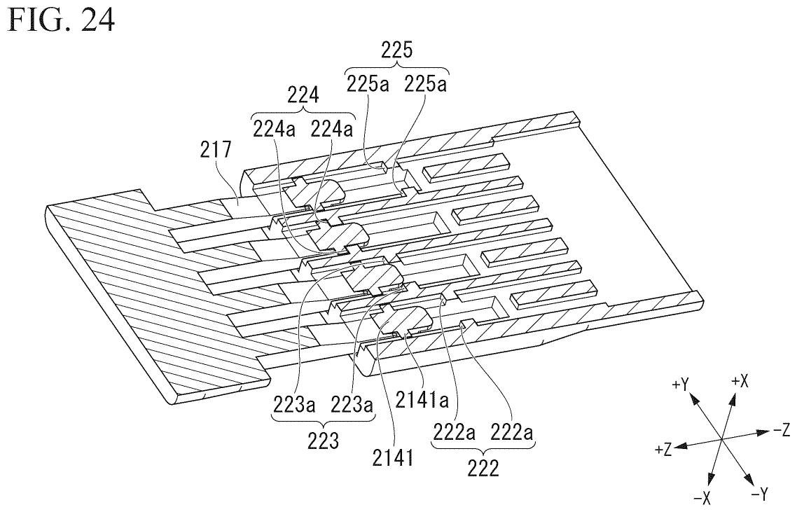

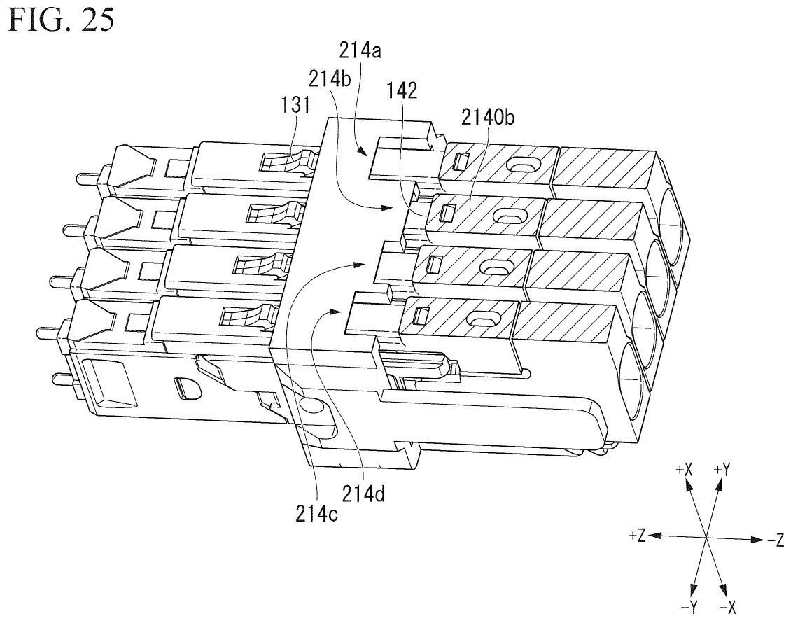

As shown in FIG. 19, the pressing portion 222 has two protrusions 222a. Similarly, each of the pressing portions 223 to 225 also has two protrusions 223a to 225a. FIG. 24 is a view in which FIG. 19 is shown as a perspective view in order to facilitate understanding. The protrusions 222a to 225a of the pressing portions 222 to 225 protrude upward (+X side) from a lower end portion (−X side end portion) of the second main body portion 221. The two protrusions 222a provided on the pressing portion 222 are provided at the same position in the longitudinal direction Z. Similarly, two protrusions 223a provided on the pressing portion 223 are also provided at the same position in the longitudinal direction Z, two protrusions 224a provided on the pressing portion 224 are also provided at the same position in the longitudinal direction Z, and two protrusions 225a provided on the pressing portion 225 are also provided at the same position in the longitudinal direction Z. The number of the pressing portions 222 to 225 is equal to the number of the connectors 100 provided in the connector with an auxiliary tool 2B. In one or more embodiments, the number of each of the pressing portions 222 to 225 and the connector 100 is four. Hereinafter, each of the four pressing portions may be referred to as a first pressing portion 222, a second pressing portion 223, a third pressing portion 224, and a fourth pressing portion 225. Positions of the pressing portions 222 to 225 in the longitudinal direction Z are different from each other. The third pressing portion 224 is positioned on the most distal end side. The second pressing portion 223 is positioned second closest to the distal end side, and the first pressing portion 223 is positioned third closest to the distal end side. The fourth pressing portion 225 is located on the most proximal end side.

Similar to the connector 100 of the first embodiments shown in FIG. 3, each connector 100 of the second embodiments includes a ferrule 110, a housing 120, an engagement protrusion 131, and a boot 2140, but the boot 2140 in the second embodiments has a different shape from the boot 140 in the first embodiments.

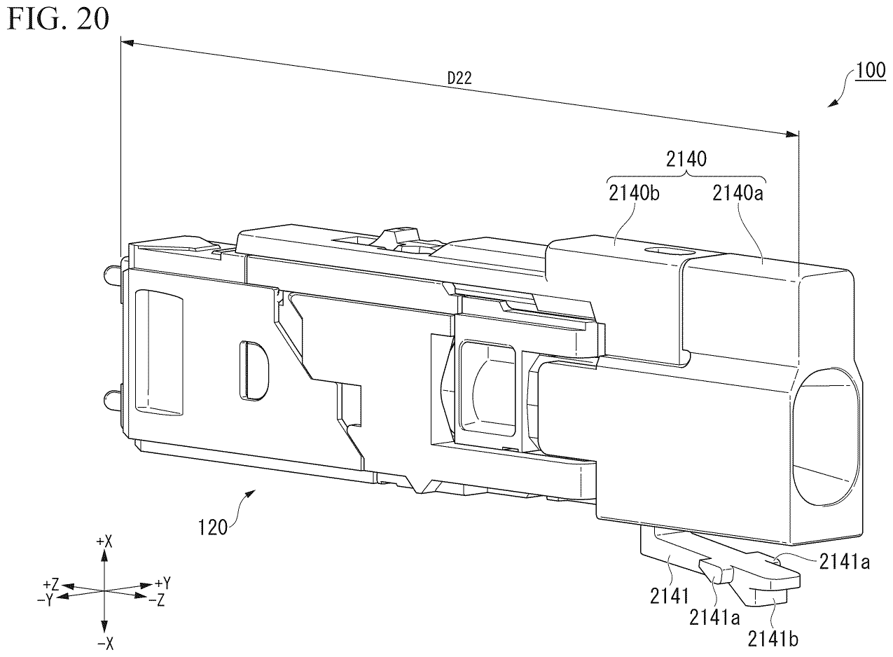

As shown in FIG. 20, the boot 2140 includes an abutting piece 2141.

The abutting piece 2141 is provided at a lower end portion of the boot main body 2140a. The abutting piece 2141 protrudes downward from the lower surface of the boot main body 2140a and extends to the −Z side. The abutting piece 2141 is elastically deformable in the up-down direction X with a connection portion (an end portion of the abutting piece 2141 on the +Z side) to the boot main body 2140a as a base point. The abutting piece 2141 is provided with two first abutting portions 2141a and one abut release portion 2141b. The first abutting portion 2141a protrudes from the abutting piece 2141 toward both sides in the left-right direction Y. The abut release portion 2141b protrudes downward from the abutting piece 2141. The two abutting portions 2141a are provided at the same position in the longitudinal direction Z.

In addition, the boot 2140 of each of the connectors 100 has the second abutting surface 142, similarly to the boot 140 of the first embodiments. The second abutting surface 142 of the second embodiments is also provided at the upper end portion of the boot 2140, similarly to the second abutting surface 142 of the first embodiments. In addition, as in the first embodiments, each second abutting surface 142 faces the release portions 214a to 214d provided inside the first main body portion 210a of the first housing 210 in the longitudinal direction Z. Since the release portions 214a to 214d have the same structures as the release portions 14a to 14d of the first embodiments, the description thereof will be omitted.

Next, the actions of the auxiliary tool 1B and the connector with an auxiliary tool 2B configured as described above will be described with reference to FIG. 12 and the like. In FIG. 12, only one adapter 3 is shown, but in an actual data center or the like, a large number of adapters 3 are densely disposed on a patch panel. In addition, although the connector on the other side is not shown in FIG. 12, the connector on the other side may be connected to the adapter 3 from the second insertion port 3b. The shape of the adapter 3 of the second embodiments is the same as the shape of the adapter 3 (see FIG. 9) of the first embodiments, and thus, not shown in the drawings.

### Connection Operation

In a case where the connection operation is performed, the connector with an auxiliary tool 2B is brought close to the adapter 3 from the state shown in FIG. 12. More specifically, the second housing 220 is gripped, and the plurality of connectors 100 are allowed to enter the first insertion port 3a (see FIG. 9) of the adapter 3. In a case where the connector 100 enters the first insertion port 3a to some extent, the first housing 210 comes into contact with the adapter 3. Further, in a case where the second housing 220 is pushed toward the adapter 3, the second housing 220 is moved to the +Z side with respect to the first housing 210. In this case, the locking portion 216 of the first housing 210 and the guide groove 221a slide with respect to each other, and the relative movement of the first housing 210 and the second housing 220 is guided.

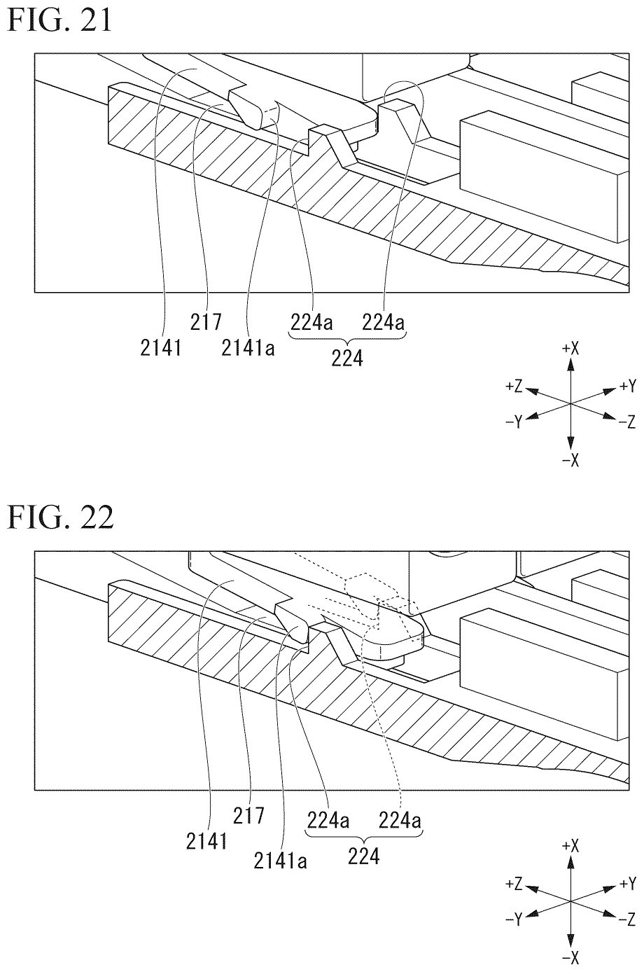

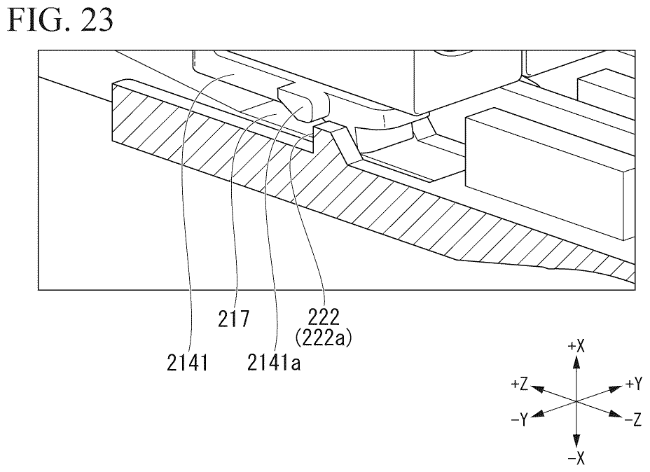

As the second housing 220 and the first housing 210 move relative to each other, a protrusion 224a of a third pressing portion 224 (see FIGS. 19 and 24) located on the most distal end side among the plurality of pressing portions 222 to 225 comes into contact with the first abutting portion 2141a (see FIGS. 20 and 24) of the third connector 100C earliest from a state where the protrusion 224a is separated from the first abutting portion 2141a of the third connector 100C shown in FIG. 21. FIG. 22 shows a state in which the protrusion 224a and the first abutting portion 2141a abut each other. Further, in a case where the second housing 220 is pushed in, a force directed to the +Z side is transmitted to the connector 100C via the first abutting portion 2141a. At this point, the first pressing portion 222, the second pressing portion 223, and the fourth pressing portion 225 are separated from the first abutting portion 2141a of each of the connectors 100A, 100B, and 100D. That is, only the third pressing portion 224 presses the third connector 100C toward the distal end side. Therefore, the operation force applied by the user to the second housing 220 is substantially the same as the force in a case where one connector 100 is pushed into the adapter 3.

In a case where the third pressing portion 224 pushes the third connector 100C by a predetermined amount, the engagement protrusion 131 of the third connector 100C is engaged with the engagement hole 3c of the adapter 3. As a result, the connection between the third connector 100C and the adapter 3 is completed (see FIG. 13). In a case where the user further pushes the second housing 220, the engagement release portion 217 abuts the abut release portion 2141b to cause the abutting piece 2141 to be elastically deformed to the +X side (see FIG. 23). As a result, the contact between the third pressing portion 224 and the first abutting portion 2141a is released.

After that, the user continues to push the second housing 220 toward the adapter 3. As a result, the second pressing portion 223 located second closest to the distal end side among the plurality of pressing portions 222 to 225 abuts the first abutting portion 2141a of the second connector 100B. Then, the second pressing portion 223 pushes the second connector 100B, so that the engagement protrusion 131 and the engagement hole 3c are engaged with each other (see FIG. 14). In addition, the contact between the second pressing portion 223 and the first abutting portion 2141a of the second connector 100B is released by the action of the corresponding engagement release portion 217.

Thereafter, the first pressing portion 222 and the fourth pressing portion 225 also push the corresponding first connector 100A and fourth connector 100D toward the distal end side in order. As a result, the engagement protrusion 131 and the engagement hole 3c of the first connector 100A and the fourth connector 100D are engaged with each other (see FIGS. 15 and 16). That is, the four connectors 100 can be collectively connected to the adapter 3 by one operation of pushing the second housing 220. In addition, for example, in a case where four connectors 100 are connected at the same time, the required operation force is four times or more the operation force in a case where one connector 100 is connected. However, in one or more embodiments, the plurality of pressing portions 222 to 225 connect each of the connectors 100 at different timings. Therefore, the operation force required for the collective connection operation is reduced.

The disconnection operation is performed in the same manner as the disconnection operation of the first embodiments. That is, in a case of performing the collective disconnection operation, in a case where the first housing 210 is moved to the proximal end side with respect to the adapter 3, as shown in FIG. 25, the second release portion 214b that is located closest to the −Z side among the plurality of release portions 214a to 214d abuts the second abutting surface 142 of the corresponding connector 100C earliest. The second release portion 214b pushes the second abutting surface 142 toward the proximal end side, so that a force toward the proximal end side is applied to the connector 100C. Accordingly, the engagement between the engagement protrusion 131 and the engagement hole 3c is released, and the connection of one connector 100C to the adapter 3 is released.

Further, in a case where the first housing 10 is moved to the −Z side, the third release portion 214c located second closest to the proximal end side abuts the second abutting surface 142 of the corresponding connector 100B. Then, the third release portion 214d pushes the connector 100B toward the proximal end side, so that the connection of the connector 100B is released. Thereafter, the remaining connectors 100A and 100D are disconnected from the adapter 3 in order. That is, the four connectors 100A to 100D can be collectively disconnected from the adapter 3 by one operation of pulling the first housing 10. In addition, for example, in a case where the four connectors 100 are disconnected at the same time, the required operation force is four times or more the operation force in a case where one connector 100 is disconnected. However, in one or more embodiments, the plurality of release portions 214a to 214d disconnect the connection of each connector 100 at different timings. Therefore, the operation force required in the case of the collective disconnection operation is reduced.

In addition, in a case of performing the individual disconnection operation, first, the second housing 220 is pulled to the −Z side with respect to the first housing 210. In this case, since the locking protrusion 216a of the first housing 210 abuts the end portion of the locking hole 221b of the second housing 220, the movement of the second housing 220 toward the −Z side is restricted. Next, for example, the locking protrusion 216a is elastically deformed outward (+Y side and −Y side) in the left-right direction Y from both side surfaces (surfaces facing the +Y side and the −Y side) of the second main body portion 221 to release the locking with respect to the locking hole 221b. Accordingly, the second housing 220 is further movable to the −Z side.

As in the state shown in FIG. 1 of the first embodiments, also in the second embodiments, a distance D21 (dimension of the first main body portion 210a in the longitudinal direction Z), which is a distance in the longitudinal direction Z from the first opening 211 to the second opening 212 of the first housing 210, is shorter than a distance D22 which is a distance in the longitudinal direction Z from the connection end surface 112 of the ferrule 110 to the rear end of the boot 2140 (end portion on the −Z side) (see FIGS. 17 and 20). Therefore, as shown in FIG. 10 of the first embodiments, in a case where the second housing 220 is sufficiently moved to −Z side, the boot 2140 of each of the connectors 100 is exposed. Therefore, by gripping the boot 2140 of any connector 100 and pulling the boot 2140 toward −Z side, any connector 100 can be disconnected from the adapter 3. As described above, the auxiliary tool 1B is configured to be able to perform both the collective disconnection operation and the individual disconnection operation.

According to the auxiliary tool 1B and the connector with an auxiliary tool 2B of the second embodiments as described above, as shown in FIGS. 12 to 16, the second housing 220 is moved in the +Z direction to be brought close to the first housing 210, whereby the engagement protrusion 131 of the connector 100 can be engaged with the engagement hole 3c of the adapter 3 one by one. Therefore, four connectors 100 can be collectively connected to the adapter 3 by repeatedly applying the same force as that of engaging one connector 100 with the adapter 3 for the number of connectors. Accordingly, the operation force required in the case of the collective connection operation can be reduced.

Here, FIGS. 12 to 16 are views showing the connector connection operation in the second embodiments, but, also in the case of the first embodiments, the second housing 20 is moved in the +Z direction to be brought close to the first housing 10, and thus the first embodiments is common to the second embodiments shown in FIGS. 12 to 16 in that the engagement protrusion 131 of the connector 100 is engaged with the engagement hole 3c of the adapter 3 one by one. Therefore, also in the case of the first embodiments, four connectors 100 can be collectively connected to the adapter 3 by repeatedly applying the same force as that of engaging one connector 100 with the adapter 3 for the number of connectors. Accordingly, also in the case of the first embodiments, the same effect as in the case of the second embodiments in which the operation force required in the case of the collective connection operation can be reduced is exhibited.

In addition, the auxiliary tool 1 of the first embodiments and the auxiliary tool 1B of the second embodiments are auxiliary tools 1 and 1B for connecting a plurality of connectors 100 having optical fibers to the adapter 3, and have a common feature that the first housing 10 and 210 and the second housing 20 and 220 are provided, the first housing 10 and 210 have a first opening 11 and 211 through which the plurality of connectors 100 protrude toward the adapter 3 and a second opening 12 and 212 facing the second housing 20 and 220, the second housing 20 and 220 have a plurality of pressing portions 22a, 23a, 24a, 25a, 222, 223, 224, and 225 that press the plurality of connectors 100, and a plurality of release portions 14a, 14b, 14c, 14d, 214a, 214b, 214c, and 214d each of which abuts respective one of the plurality of connectors 100 in a case where the first housing 10 and 210 are separated from the adapter 3 are provided inside the first housing 10 and 210.

In the second embodiments, the number of the connector 100, the pressing portions 222 to 225, the release portions 214a to 214d, and the like is four. However, these numbers can be changed, and may be two, three, five, or more.

In addition, in one or more embodiments, the positions of the plurality of release portions 214a to 214d in the longitudinal direction Z are different. However, even in a case where the positions of the release portions 214a to 214d in the longitudinal direction Z are the same, it is possible to perform the collective connection operation and the collective disconnection operation by using the auxiliary tool 1. Therefore, it is not essential that the positions of the plurality of release portions 214a to 214d in the longitudinal direction Z are different from each other. Similarly, it is not essential that the positions of the plurality of pressing portions 222 to 225 in the longitudinal direction Z are different.

In addition, in one or more embodiments, the two protrusions 222a to 225a provided on the pressing portions 222 to 225 are provided at the same position in the longitudinal direction Z, and the two first abutting portions 2141a in the abutting piece 2141 are provided at the same position in the longitudinal direction Z. However, the two protrusions 222a to 225a and the two first abutting portions 2141a do not necessarily have to be provided at the same position in the longitudinal direction Z.

In addition, the second housing 220 of one or more embodiments may be provided with a handle similar to the handle 30 provided in the second housing 20 of the first embodiments.

It is possible to replace configurations of the above embodiments with any known configurations without departing from the scope of the invention. It is also possible to properly combine above embodiments and modification examples.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 1B Auxiliary tool
2, 2B Connector with auxiliary tool
3 Adapter
3c Engagement hole
10, 210 First housing
11, 211 First opening
12, 212 Second opening
13 Contact surface
14a to 14d, 214a to 214d Release portion
15 Avoidance hole
20, 220 Second housing
22 to 25 Pressing piece
22a to 25a, 222 to 225 Pressing portion
222a to 225a Protrusion
30 Handle
100 Connector
101 Optical fiber
110 Ferrule
111 Fiber hole
112 Connection end surface
120 Housing
131 Engagement protrusion
140, 2140 Boot

1. An auxiliary tool for connecting connectors including optical fibers to an adapter, the auxiliary tool comprising:
a first housing; and
a second housing, wherein
the first housing has:
a first opening through which the connectors protrude toward the adapter, and
a second opening facing the second housing,
the second housing has pressing portions configured to press the connectors, and
the first housing has release portions inside each configured to abut a respective one of the connectors when the first housing is separated from the adapter.

2. The auxiliary tool according to claim 1, wherein the pressing portions are configured to enter the first housing from the second opening to press the connectors.

3. The auxiliary tool according to claim 1, wherein the pressing portions are disposed at different positions in a direction in which the first housing and the second housing are disposed.

4. The auxiliary tool according to claim 1, wherein the release portions are disposed at different positions in a direction in which the first housing and the second housing are disposed.

5. The auxiliary tool according to claim 1, wherein
the first housing has:
a contact surface configured to contact with the pressing portions when the pressing portions press the connectors; and
avoidance holes on the contact surface, wherein the pressing portions are configured to enter the avoidance holes after the connecting the connectors to the adapter.

6. The auxiliary tool according to claim 1, further comprising a handle attached to the first housing.

7. A connector with an auxiliary tool comprising:
the auxiliary tool according to claim 1; and
the connectors inserted into an inside of the first housing and an inside of the second housing, wherein
each of the connectors comprises:
optical fibers;
a ferrule having fiber holes into which the optical fibers are inserted;
a housing that holds the ferrule;
an engagement protrusion configured to engage with an engagement hole of the adapter; and
a boot at an end of the each of the connectors on a side opposite to the ferrule.

8. The connector with an auxiliary tool according to claim 7, wherein, in a direction in which the first housing and the second housing are disposed, a distance from the first opening to the second opening is shorter than a distance from a connection end surface of the ferrule to a rear end of the boot.

9. The connector with an auxiliary tool according to claim 7, wherein the second housing is movable to be separated from the first housing until the boot is exposed.

10. The connector with an auxiliary tool according to claim 7, wherein
the boot comprises an abutting piece that protrudes downward from a lower end of the boot and extends toward a proximal end, and
the pressing portions of the second housing are configured to press the boot toward a distal end by abutting the abutting piece.

11. The connector with an auxiliary tool according to claim 10, wherein each of the pressing portions comprises two protrusions protruding upward from a lower end portion of the second housing.
